(19) United States
(12) Patent Application Publication
(10) Pub. No.: US 2021/0334705 A1
(43) Pub. Date: Oct. 28, 2021

(54) PERSISTED MACHINE LEARNING-BASED SENSING OF RF ENVIRONMENTS

(71) Applicant: Shared Spectrum Company, Vienna, VA (US)

(72) Inventors: Ihsan Akbar, Chantilly, VA (US); Scott Seidel, Fairfax, VA (US); Mark Allen McHenry, McLean, VA (US)

(21) Appl. No.: 17/238,511

(22) Filed: Apr. 23, 2021

Related U.S. Application Data
(60) Provisional application No. 63/014,996, filed on Apr. 24, 2020.

(51) Int. Cl. G06N 20/00; G06K 9/62; G06K 9/00

(52) U.S. Cl. CPC G06N 20/00; G06K 9/6284; G06K 9/00536; G06K 9/00523; G06K 9/6256

(57) ABSTRACT

A RF Environment Learning Module includes a machine learning/artificial intelligence sensing controller process that schedules feature vector extractors and one or more machine learning (ML) signal classifiers in order to classify received radio signals and a ML-based validation process that reasons over the classification results to determine if they are valid or reasonable.

### COPYRIGHT NOTICE

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright © 2020, Shared Spectrum Company.

### BACKGROUND OF THE TECHNOLOGY

### 1.1 Field of the Technology

The described technology relates to hardware and software systems for operating software defined radios, in particular to the systems, software, and methods for classifying previously unknown received radio signals that remain unclassified after using signal classification techniques defined for the radio. The technology uses machine-learning techniques to automatically schedule feature vector extractors and configures one or more signal classifiers on the basis of the extracted signal features as processed by machine learning techniques, followed by one or more validation processes that determine the validity and reasonableness of the classification results.

The technology herein has applications in the areas of Dynamic Spectrum Access (DSA) radio design and operation and the use of machine learning techniques to dynamically classify unknown radio signals using RF environment and signal attribute data, and to enable the radio to persistently classify these signals when they are subsequently encountered. The technology uses machine-learning techniques to automatically update existing signal classifiers, and to create and train new signal classifiers, using current digital signal data acquired by the DSA radio for a given RF environment. The technology provides flexibility in digital signal classification by not being tied to a pre-determined configuration of feature extractors and signal classifiers, supporting the persistent classification of digital signals that were previously unknown or difficult to identify, such as simultaneous or overlapping signals, signals near or below the noise floor, or known signals occurring in an unexpected frequency channel.

The technology herein also provides considerable resource savings in terms of sensing, processing, and battery cost to a DSA radio system by using machine-learning techniques to select and fine-tune a set of feature extractors and signal classifiers needed to identify the signals in a particular RF environment.

### 1.2 Related Technologies

Known radio designs feature signal classification systems that are not configured to dynamically adapt their configuration and the radio's operation based on what is known about the current and continually changing radio frequency (RF) spectrum environment. The known systems include applying a pre-determined set of signal classifiers or scheduling a single, pre-selected, machine-learning-based classifier on a contingency basis.

FIG. 1 (1000) is a diagram of a portion of a dynamic spectrum access (DSA) radio communication device employing a predefined set of signal classifiers statically configured to identify incoming digital signal data. The digital signal data (1010) is processed by a pre-defined configuration of signal classifiers (1020a-d) which attempt to classify the signal. For example, the signal classifiers deployed on a mobile cellular device might include classifiers for LTE, Wi-Fi, and Bluetooth waveforms. The classifiers are typically run in series in a pre-determined order as defined by a radio configuration until a signal is classified. Output from any classifiers that successfully identify the signal (1025) is passed along to a channel management component (1070) that makes control decision(s) (1090) for the DSA radio based on the classified signal type. If the signal is still unknown after all the pre-configured classifiers (1020a-d) have been run (1030), some prior art systems use one or more machine learning techniques (1040) to select and run additional pre-configured classifier(s) from a list (1050a-d) of pre-configured classifiers, and successful results are passed to the channel management component. If the signal is still unknown at the end of the ML process (1060), there is no further means provided for signal identification.

While machine learning techniques are used to choose between the additional pre-defined classifier selections, the radio's existing classifier configurations are not updated, nor are new classifiers configured and added to the radio's processing configuration as a result of the machine learning techniques applied to the attributes of the previously unknown digital signal data and/or the RF environment the radio is operating within.

Some known DSA radio systems use machine-learning techniques to select a singular ML-based classifier, such as a Gaussian Mixture Model, Bayesian classifier, etc. to attempt to classify signals after non-ML-based classifiers have failed to make an identification, as is shown in FIG. 1. However, these ML-based classifiers are pre-configured and come from a pre-determined list, and the known DSA radio system does not automatically train new classifiers or update classifiers based on new data regarding a particular RF environment, or particular signal attributes. Thus, there is no further way to proceed, without external intervention, if a radio signal still is not identified after an ML-based classifier is selected and run.

The known DSA radio systems do not take the radio's historical and current RF environment into account when configuring new signal classifiers. Known systems process RF spectrum data using the same set of feature extractors and the same set of classifiers regardless of variables such as location, knowledge of the past and current RF signal environment, time of day, etc. As a result, the known systems often process feature vectors using a classifier that is incapable of classifying signals in the current RF spectrum environment.

The known DSA radio systems have inflexible configurations, and cannot adapt by updating existing classifiers or adding new classifiers without external inputs. Some known DSA radio systems terminate without making a signal identification if they fail to classify a signal using a series of pre-defined signal classifiers, even if the signal is a known type. For example, known DSA radio systems cannot identify a Wi-Fi type signal occurring outside of a predefined Wi-Fi frequency range that is configured in a classifier. The known system has no way to re-train the pre-defined classifier to add a different frequency range to its definition. The known DSA radio systems also have no automatic way to add a new classifier when they encounter a set of signal attributes they have not encountered before. Such signal attributes, even when they cluster together and consistently recur in a particular RF environment, are continuously classified by the radio as “unknown.”

Similarly, known DSA radio systems cannot identify signals that are individual components of complex signals and waveforms. Such complex signals may represent simultaneous or overlapping signals, such as an LTE signal overlaid by a Wi-Fi signal. Complex signals also may represent a class of signals that have a high signal-to-noise ratio by being near or below the noise floor (i.e., the signal is overlaid by noise vs. overlaid by another signal). The known DSA radio systems have no way of sorting out these complex signals and waveforms into multiple components that are each identifiable individually.

The known DSA radio systems use significant processing and battery resources to execute the pre-configured set of signal classifiers, some of which are not needed, or are not capable of classifying signals in a particular RF spectrum environment, or are not effective because they require excessive system resources. The known DSA radio systems end up expending sensing, computer processing, and battery resources inefficiently for classifying signals in a particular RF spectrum environment. This is especially detrimental when deployed on a battery-powered device. For example, a known neural network-based classifier classifies multiple signal types, which should be an improvement over using several single-signal type classifiers. However, each individual signal type requires new nodes to be added to the neural network, and this type of classifier also requires a larger spectrum revisit rate, both of which cause large operational costs to the system. A known DSA radio system with a neural network based classifier in its pre-determined list of classifiers is not able to automatically bypass the use of this classifier and dynamically select other classifiers requiring fewer resources.

### BRIEF DESCRIPTION OF THE DRAWINGS

The features of the present technology will best be understood from a detailed description of the technology and example embodiments thereof selected for the purposes of illustration and shown in the accompanying drawings in which:

FIG. 1 illustrates the signal and classification processing flow (1000) though a typical DSA radio processing system.

FIG. 2 depicts a schematic diagram of the architecture of an example DSA-enabled radio (2000) containing the RF Environment Learning Module (2100) according to the technology of the invention.

FIG. 3 depicts a schematic diagram of an example RF environment learning module (2100) according to the technology of the invention.

FIGS. 4A and 4B depict flowcharts of an example process (4000) where the trained ML sensing controller of the RF environment learning module generates and executes signal sensing and processing plans according to the technology of the invention. FIG. 4A depicts a sensing and signal processing process, and FIG. 4B depicts a real time ML training process.

FIG. 5 depicts data flow (5000) through an example embodiment of the RF environment learning module according to the technology of the invention.

FIG. 6 illustrates information flow (6000) of an implementation of a simple sensing and signal processing plan according to the technology of the invention.

FIG. 7 illustrates information flow (7000) of an implementation of a more complex, resource intensive, sensing and signal processing plan according to the technology of the invention.

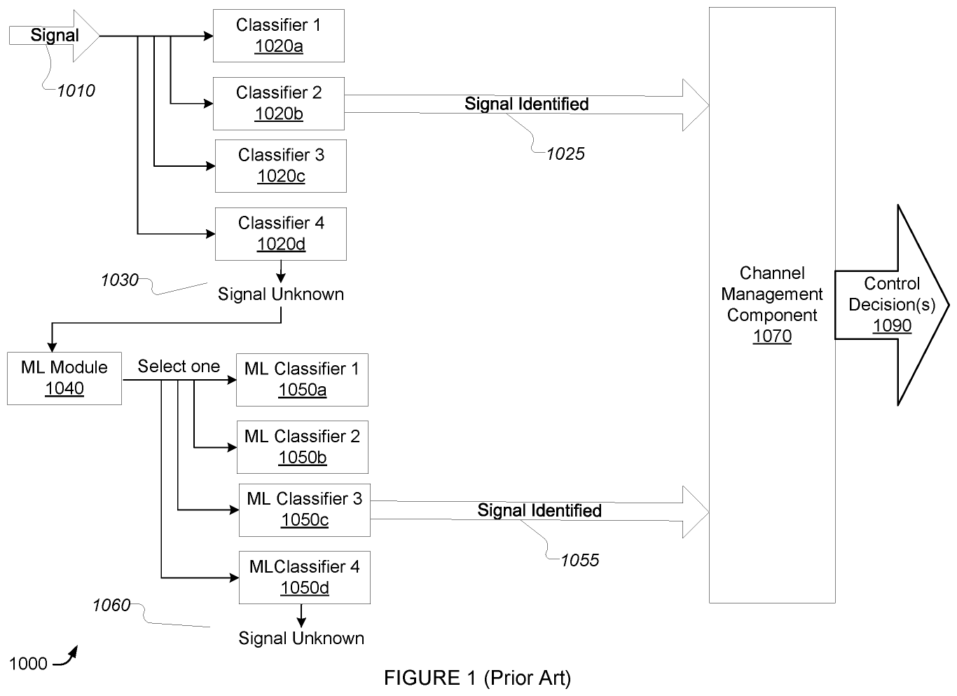

### DETAILED DESCRIPTION

### 1.3 Overview

Embodiments disclosed herein provide a DSA-enabled radio system incorporating a RF Environment Learning Module that includes a machine learning (ML) sensing controller that orchestrates data collection by the DSA-enabled radio and processing by the modules of the RF environment learning module through the use of a signal sensing and processing plan.

The ML sensing controller uses machine learning techniques to create one or more signal sensing and processing plan(s) configured for implementation in the DSA-enabled radio's current RF operating environment, for example by dynamically configuring feature vector extractors and signal classifiers, including single. multiple, and machine-learning based signal classifiers, before use in identifying received RF signals. The ML sensing controller obtains information about the current RF environment and historical information collected about a current environment and other RF environments to pre-determine what regions of the spectrum are likely in use, and what types of signals are most likely to be present. It then may dynamically select a plan specifying appropriate feature extractors and/or signal classifiers associated with the current RF environment, thereby reducing battery and processing overhead by reducing the execution of extractor and classifier programs that are not likely to produce positive signal identification results. Portions of the RF environment that are unlikely to have meaningful signals are processed subsequently to the classifiers and extractors that are likely to produce currently useful results, or are processed using additional resources such as the machine learning aspects of the DSA-enabled radio.

A signal sensing and processing plan as disclosed herein provides the instructions to the DSA-enabled radio system that may specify the order, frequency, and/or type of feature vector extractors and signal classifiers to execute to enable signal identification of known and previously unidentified signals to the DSA-enabled radio system. It also may provide configuration parameters to those extractors and classifiers that require them.

A DSA-enabled radio system as disclosed herein may be initialized for the current or expected RF environment by training the ML sensing controller on historical data prior to deployment. Historical data may include, for example, past spectrum measurement data, past signal sensing and processing plans, and/or past signal identification results. The DSA-enabled radio system may acquire this historical data from previous spectrum measurements by the radio, connected remote sensors, and/or a database of previously collected sensor data. The ML sensing controller uses the pre-deployment training to configure an initial set of feature extractors and classifiers, which are incorporated into an initial signal sensing and processing plan.

After the DSA-enabled radio system is initialized using the historical data, the ML sensing controller uses the information in the initial signal sensing and processing plan to perform real-time signal sensing of the RF environment to collect RF signal data. In an implementation, the DSA-enabled radio system executes a selected set of feature extractors on the input RF signal and processes the resulting signal attribute information through the selected classifiers. If the signal remains unclassified, this process may continue iteratively, with the ML sensing controller using additional feature extractors and/or signal classifiers, as specified in the initial signal sensing and processing plan.

Alternatively or in addition, the DSA-enabled radio system may execute the initial set of classifiers to process the collected RF data and attempt to classify as many signals as possible. If all signals are not classified, the DSA-enabled radio system next uses one or more feature vector extractors to determine additional information about features that may be indicative of any signals present in the collected RF data. By only using feature extractors when signals remain unclassified after the initial classification pass, the system may greatly reduce its processing overhead, and thus CPU load and battery drain. Additionally, by breaking down unclassified signals into multiple feature vectors through the use of feature extractors, the DSA-enabled radio system reveals signal attributes that are subsequently used by the system as additional data inputs to configure and/or select classifiers for subsequent signal processing.

The DSA-enabled radio system may use machine learning to re-configure existing feature extractors and classifiers and/or to create new feature extractors and classifiers that are configured to identify and classify previously unidentified features and signals. The machine learning aspect allows the radio system to fine-tune the operation of existing feature extractors and classifiers to the existing RF environment and signal attributes, reduce the number of unclassified signals, and improve the use of system resources without the necessity for external updates. The ML sensing controller uses a novelty detection module to collect additional RF signal data and determine the feature extractors that will yield signal attributes that make a new signal type distinct, and one or more classifiers to recognize and identify those signal attributes. The ML sensing controller then uses a classifier training module to train the DSA radio system to recognize the new signal type. After the new feature extractors and classifiers are configured and tested, the DSA-enabled radio system uses machine learning to update an existing sensing and processing plan or create a new sensing and processing plan, including the new or updated feature extractors and classifiers described above, in order to optimize the radio's feature and signal identification activities.

In a particular implementation, the DSA-enabled radio system uses historical information collected about signal attributes to identify signals in situations where a known signal type is present in an unexpected portion of the RF environment. This method of classification reduces the number of classification failures evidenced in prior radio systems when a signal matches some but not all of the attributes required in a pre-determined classifier and the signal is not identified as a result. The DSA-enabled radio system is re-trained to identify the known RF signal when it appears in an unexpected area of the RF environment, and the DSA-enabled radio system uses machine learning to update the existing sensing and processing plan with the additional environmental data for that signal type.

The DSA-enabled radio may use multiple methods to deal with the issue of simultaneous or overlapping source signals, or signals intermixed with noise. For example, the DSA-enabled radio system may use extractors to separate complex signals into feature vectors, permitting classification of the complex signal into multiple signals of differing types, or multiple signals of the same type, or one or more signals mixed with noise. Some of these signals are categorized as known types by the classifier. If the feature vector extractors are insufficient to completely identify a complex signal, the DSA-enabled radio system makes another pass through the signal data and executes a blind signal separation (BSS) module to separate source signals before passing them to the extractors.

After a signal is identified by the classifier(s), the DSA radio passes the signal classification results to a ML validation module for verification using ML statistical methods. If the signal identification is verified, the signal classification results are used by the DSA radio system to make control decisions. If the signal identification is rejected, the ML sensing controller updates the sensing and processing plan and makes further attempts to identify the signal using a different combination of vector extractors and classifiers. In the case where multiple classifiers were used to identify a signal, the classification results are merged by a sensor fusion module before they are sent to the ML validation module.

These and other aspects and advantages will become apparent when the Description below is read in conjunction with the accompanying Drawings.

### 1.4 Definitions

The following definitions are used throughout, unless specifically indicated otherwise:

| TERM | DEFINITION |
|---|---|
| Channelization | The division of a spectrum range into discrete portions. |
| | The channelization is the definition of a center |
| | frequency and bandwidth of a signal or expected signal. |
| DSA | Dynamic Spectrum Access |
| Feature/Feature | Unique spectral signatures obtained from I/Q data. |
| Vector | |
| I/Q data | Signal modulation data |
| Reasons over | Analyzes outputs or results of a process, including |
| | checks for consistency and validity. |
| RF spectrum | The historical and current utilization of the radio |
| environment | frequency (RF) spectrum that is received by a receiver |
| | at a specified location. |

### 1.5 System Architecture

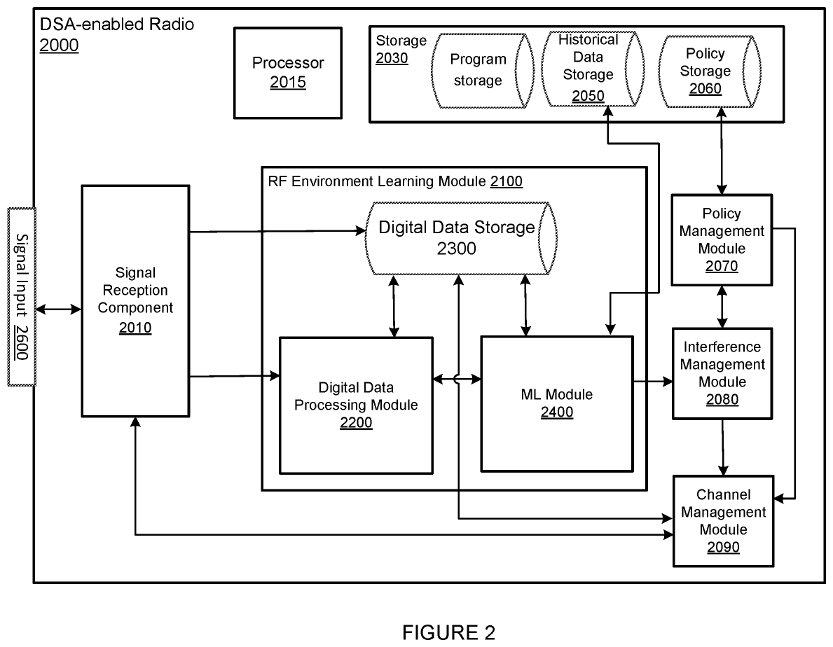

As depicted in FIG. 2, an illustrative RF Environment Learning Module (2100) may be implemented as part of a DSA-enabled radio (2000). The DSA-enabled radio's standard architecture includes a processor (2015) executing one or more radio control software (programs and modules) (e.g., program/modules 2010, 2070, 2080, 2090, 2200. 2400), and storage (2030) used for storage of the above-mentioned programs, modules, and data (e.g., historical data storage 2050 and policy storage 2060) used by the radio system. Analog RF signal data is received by the radio system through a signal input (2600) and is received and converted into digital I/Q data by a signal receiver component (2010) that is controlled and managed by a channel management module (2090). The signal receiver component is either a software-defined RF receiver or the receive portion of a software-defined transceiver. The digital I/Q data are used as inputs by the RF environment learning module and its modules. After the digital I/Q data are processed and signals within the digital I/Q data are identified and verified by the RF environment learning module, the results may be shared with the DSA-enabled radio's policy management module (2070), interference management module (2080), and/or channel management module (2090), where they may be used by the DSA-enabled radio to make control decisions.

The processor (2015) of the DSA-enabled radio system preferably includes a single chip microprocessor, a central processing unit (CPU), or the like suitable for executing user defined loadable software and/or firmware modules. Alternatively or in addition, some or all data processing can be carried out using one or more hardware components that do not make use of loadable software, such as ASICs (Application Specific Integrated Circuits), FPGAs (Field Programmable Gate Arrays), or others, without deviating from the present invention.

The storage (2030) preferably includes a non-volatile memory device suitable for storing the user defined loadable software or firmware modules and executing the software or firmware in cooperation with the software modules of the DSA-enabled radio system. In addition, the storage (2030) may operate to store digital data generated by elements of the local device and to communicate with other DSA or non-DSA enabled radio devices, including Wi-Fi enabled devices, and/or to exchange data with the other devices and/or to receive updates to any software or firmware module operating on the DSA enabled radio device. In non-limiting example embodiments the digital data storage module may include flash memory devices, hard disc drives, Read Only Memory (ROM), Programmable Read Only Memory (PROM), Erasable Read Only Memory (EPROM), Electrically Erasable Programmable Read Only Memory (EEPROM), or combinations of these or other devices. The storage (2030) may include one or more physical devices, which may be accessed by other components of the system individually or as one or more logical storage locations.

Alternately, numerous other well-known digital data processor and data storage modules, including a unitary device that operates as both a digital data processor and digital data storage module, are usable without deviating from the present invention.

Continuing to refer to FIG. 2, in an example arrangement as shown the RF environment learning module (2100) is operably connected to components of the DSA-enabled radio system, including historical data storage (2050), signal receiver component (2010), and interference management module (2080). The historical data storage is used to supply initial historical spectrum measurement data, historical spectrum sensing and processing plans, and historical signal identification results to initialize and train the ML sensing controller (2410). The signal receiver component (2010) receives analog RF data from the signal input (2600), converts it to digital I/Q data, and sends the resulting I/Q data as input data to the feature extractors (2220a-b) or the blind signal separation (BSS) module (2270), or is stored in the digital signal buffer (2310). The interference management module (2080) receives output data (such as confidence scores) from the ML validation module (2440) and uses them to make management decisions that are passed along to the channel management module (2090).

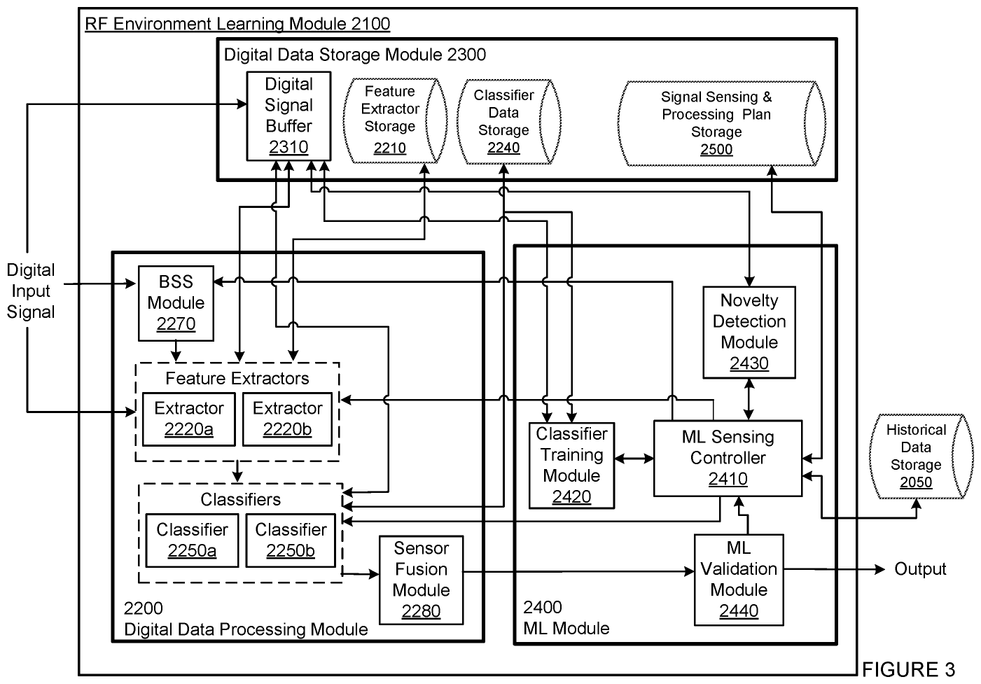

Referring to FIG. 3, an example of a RF environment learning module (2100) as disclosed herein is depicted in a detailed non-limiting schematic diagram (2100). The RF environment learning module uses the DSA-enabled radio's processor (2015) to run its modules, or, alternately, has its own on-board processor (not shown). The RF environment learning module may include three modules: a digital data storage module (2300), a digital data processing module (2200), and a machine language (ML) module (2400). The modules interoperate with each other, and with components of the DSA-enabled radio (2000) in order to provide machine-learning support for signal classification, and automatic updates of signal sensing and processing plan(s) (2500) used by the DSA-enabled radio to acquire and identify signal data in real time. Each module may be implemented in software and/or hardware, and may use one or more dedicated circuits, processors, or other arrangements; or one or more modules may be implemented and/or executed using common resources.

The ML sensing controller (2410) of the ML module (2400) dynamically orchestrates most of the functions of the RF environment learning module by controlling the feature extractors and classifier programs based upon previously classified features and signal identifications. The ML sensing controller acquires historical data from historical data storage (2050) of the DSA-enabled radio and creates and stores an initial signal sensing and processing plan (2500). The initial signal sensing and processing plan is then used to instruct the signal input (2600) of the DSA-enabled radio to take RF signal readings from a specified RF environment and pass them to the signal reception component (2010), where they are converted to digital I/Q data, which is passed to the digital data processing module (2200). The ML sensing controller (2410) follows the signal sensing and processing plan to instruct the modules of the digital data processing module (2220a-b, 2250a-b, 2270, 2280) to process the digital I/Q data and produce a classification result, which is passed back to the ML module (2440) for verification by the ML validation module (2440).

The digital data processing module (2200) includes one or more programs or modules that implement signal classifiers (2250a-c), feature extractors (2220a-b), and other signal processing modules (2270, 2280) that are configured in accordance with a signal sensing and processing plan to attempt the identification and classification of signals in digital RF data acquired by the DSA-enabled radio. Feature extractor data (2210) and classifier data (2240) are stored by the digital data storage module (2300).

The digital data storage module (2300) may include one or more data stores (e.g. 2210, 2240, 2500) which can be databases, data tables, or other data structures used to persistently store information relating to the operation of the RF environment learning module in a memory of the DSA-enabled ratio (such as the data store 2030 of FIG. 2), and a digital signal buffer (2310) which temporarily stores digital I/Q data generated by the signal receiver component of the DSA-enabled radio. In non-limiting illustrative embodiments where the digital data storage module is configured separately from storage 2030, the digital data storage module (2300) may include the same types of devices described for the storage (2030) of the DSA-enabled radio, as described above. In some embodiments, the digital data storage module is part of the storage (2030) of the DSA-enabled radio.

Besides the ML sensing controller and the ML validation module, the ML module (2400) also may include an ML-based novelty detection module (2430) for identification of new signal types requiring new classifiers, and an ML-based classifier training module (2420), for the training or re-training of new or existing signal classifiers.

### 1.6 Operation of an Example DSA Radio Including an RF Environment Learning Module

An RF environment learning module (2100) as disclosed herein may coordinate with one or more other existing components and modules of a DSA-enabled radio (2000), such as described with respect to FIG. 2, in order to have the radio perform its functions with no supervision and dynamically update its sensing strategies and signal classification abilities. The ML sensing controller uses machine-learning techniques to create and modify sensing and processing plans to operate and update components in the RF environment learning module, such as classifier (2250a-c) and feature extractor (2220a-b) modules. The ML techniques make it possible for the RF environment learning module to dynamically adapt the DSA radio operations to changing RF environments and to positively identify a higher percentage of RF signals.

Table 1 describes examples of feature extractors, features that they extract, and classifiers that process signals and the extracted features.

TABLE 1
Example Feature Extractors, Features, and Classifiers

| Feature Extractor | Features | Classifier | Notes |
|---|---|---|---|
| Time domain sync | I/Q time domain sync | LSTM | Requires full bandwidth capture |
| pattern extractor | pattern | | Requires prior knowledge of |
| | | | waveform |
| | | | Doesn't require frequency domain |
| | | | conversion |
| | | | More accurate than some other |
| | | | classification techniques |
| Phase extractor | Phase | LSTM | Requires full bandwidth capture |
| Duty cycle extractor | Duty cycle | LSTM | Longer time capture allows |
| | | | obtaining waveform protocol level |
| | | | features |
| | | | Requires large number of samples |
| | | | Reduces mis-classification rate |
| | | | Doesn't require detailed |
| | | | knowledge of waveform |
| Eye diagram | Eye diagram | CNN | Requires significantly less number |
| extractor | | | of I/Q samples |
| | | | Faster processing (no frequency |
| | | | domain conversion) |
| | | | Doesn't require prior knowledge |
| | | | of waveform |
| PSD Mask | PSD Mask | CNN | Requires significantly small |
| (bandwidth) extractor | (bandwidth) | | number of samples |
| | | | Requires frequency domain |
| | | | conversion |
| | | | Does not discriminate among |
| | | | different waveforms that use same |
| | | | modulation (e.g., commercial vs. |
| | | | DoD signals) |
| | | | Requires full bandwidth capture |
| Spectrogram | Spectrogram features | CNN | Captures waveform protocol layer |
| extractor | (e.g. RF frequency, | | specific features |
| | Pulse Repetition | | Requires large number of samples |
| | Interval (PRI), and | | Fast processing (FFT based) |
| | Pulse Width (PW)) | | Doesn't requires full bandwidth |
| | | | capture |
| Constellation | Constellation | CNN | Requires significantly less number |
| diagram extractor | diagram | | of samples |
| | | | Fast processing |
| | | | No frequency domain conversion |
| | | | Doesn't discriminate among |
| | | | waveforms that use same |
| | | | modulation |
| Cyclostationary | Cyclostationary | CNN | Allows sub-noise detection |
| profile extractor | profile | | Requires large number of samples |
| | | | in case of sub-noise signals |
| | | | Significantly more accurate and |
| | | | robust than other features |
| | | | Slow processing/computationally |
| | | | lot more complex than other |
| | | | techniques |

The RF environment learning module directs the ML sensing controller (2410) to use prior sensing, classification, and reasoning results (e.g., historical data 2050) to create an initial signal sensing and processing plan (2500). The ML sensing controller is described as “trained” once it has gone through the initialization process and the initial signal sensing and processing plan has been created. The signal sensing and processing plan identifies the process flows the trained ML sensing controller should follow as differing signals are sensed by the DSA-enabled radio. The plan may be optionally exported as a policy for controlling one or more other sensing controllers.

In an embodiment, a DSA-enabled radio may receive I/Q data from the radio hardware and select a spectrum processing plan associated with the current RF environment known to the radio. The spectrum processing plan may be selected based upon a combination of GPS-based geolocation and previously identified signal information and may include a first PSD feature extractor. Based upon the selected spectrum processing plan, the radio determines that there are unknown signals in specific spectrum bands and determines that it should performed further processing based upon its findings. If the unknown signal is of known type but is not present in a known spectrum band, the initial classifier may initially classify the signal (for example, a Wifi signal in an unauthorized band). In this case, the reasoner component of the RF environment learning module is used to determine that the classified signal is not in a proper band, and orchestrates further feature extraction and classification on the captured signal data. In this case, the additional classifiers may include a sync correlator-based classifier, an eye diagram feature extractor, and a spectrogram analysis feature extractor. The RF environment learning modules uses the combination of results to confirm (a process called sensor fusion) to determine that the signal is actually a WiFi signal. The RF environment learning module then updates/create a spectrum processing plan and updates the historical information to include its new spectrum analysis findings, thus causing the radio to learn about a WiFi signal present in a particular spectrum band. This permits the DSA-enabled radio to improve its performance as new spectrum utilization is identified. The improved performance can be made universally (e.g. the new WiFi signal band checking occurs any time a signal is identified) or on a specific RF environment basis.

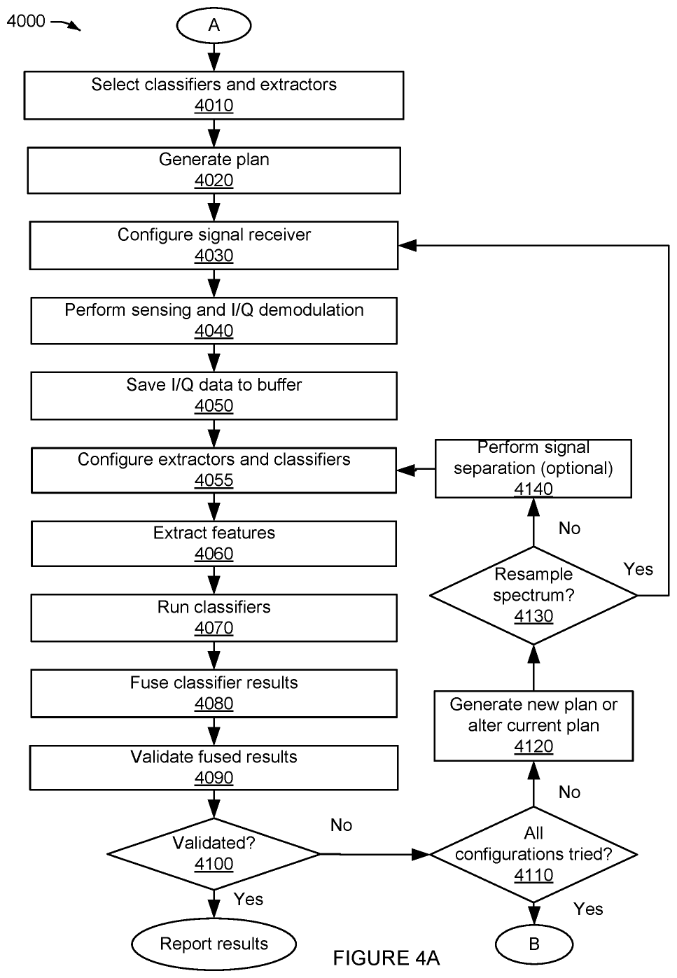

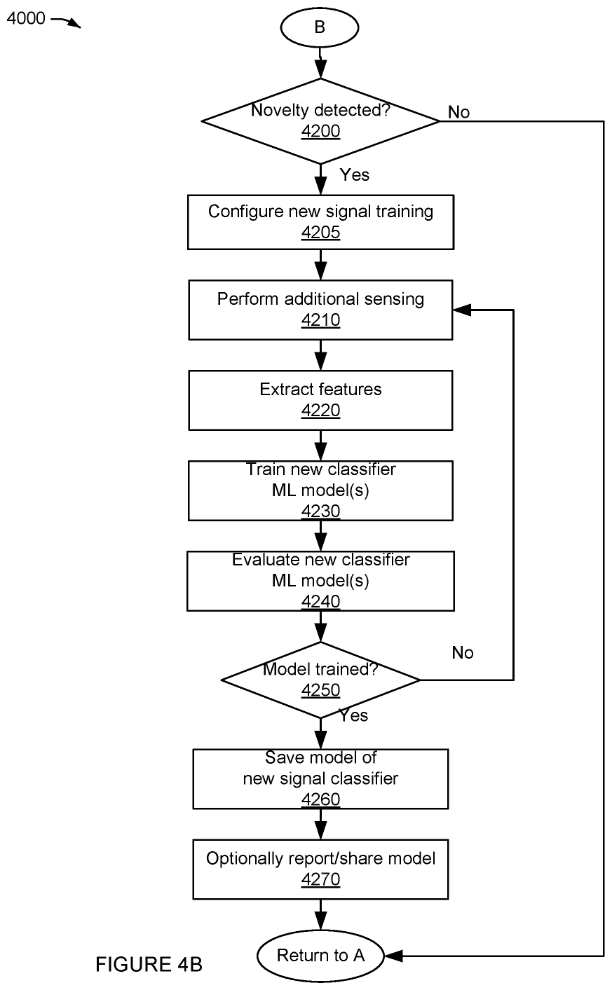

Referring to FIGS. 3, 4A, and 4B, an example of a ML sensing controller (2410) as disclosed herein may be trained to predict which signal classifiers of a plurality of signal classifiers are likely to successfully classify signals in a current RF spectrum environment. The ML sensing controller is trained using data including historical spectrum information (e.g., historical signal classifications by one or more classifier systems, historical spectrum reports, historical known fixed location emitters), historical RF environment learning module classification results (e.g., successful or unsuccessful historical classification results), location-based information (e.g., buildings, infrastructure, bodies of water, tree cover and other location-specific potential influencers of RF spectrum), atmospheric conditions, and information pertaining to other potential influencers of RF spectrum and/or classification results.

In operation, the trained ML sensing controller processes input data such as location, time of day, historical sensing results (and/or other indications of expected signals), and recent sensing results by the RF environment learning module and/or one or more other signal classification systems, and generates output data that includes information useful for generating a sensing and signal processing plan. The information included in the output data includes, for example, likely and unlikely signals in the current spectrum environment, classifiers predicted to successfully classify likely signals, and signal receiver component settings and sensing schedule settings likely to capture useful RF signal data. The trained ML sensing controller processes the output data to generate a sensing and signal processing plan that the RF environment learning module implements to attempt to classify signals.

The trained ML sensing controller optionally selects one or more signal classifiers based on information including previous signal classification results. If a first signal classification operation fails to successfully classify signals in the current RF spectrum environment, the trained ML sensing controller reasons over results of the first signal classification operation to select one or more additional or alternative signal classifiers to use in a second signal classification operation. In a particular example, the trained ML sensing controller selects and executes a first, relatively less resource intensive, signal classifier for a first signal classification operation. If the first signal classification operation fails to classify signals, the trained ML sensing controller selects and executes a second, relatively more resource intensive, signal classifier, or multiple signal classifiers, for a second signal classification operation. The trained ML sensing controller iteratively selects and executes increasingly resource intensive signal classifiers or more resource intensive groups of signal classifiers until a signal classification operation is successful. Iterative selection and use of signal classifiers is advantageous in that more resource intensive classifiers or groups of classifiers are only used when they are needed, i.e., when less resource intensive classifiers fail.

In a particular example, the ML sensing controller is trained to predict which of the plurality of signal classifiers are most likely to successfully classify signals in the current RF spectrum environment and operates to only select and prioritize the execution of (or limits execution to) those signal classifiers that are likely to succeed at classifying a signal. This is advantageous in that the RF environment learning module saves computing and battery power resources by not executing signal classifiers that are unlikely to succeed at classifying a received signal. In another example, the controller predicts that each of a plurality of signal classifiers are likely to succeed and selects and executes a subgroup of one or more of the plurality of signal classifiers based on operational characteristics of the signal classifiers or on other criteria. For example, the controller selects and prioritizes the execution of a signal classifier that is less resource intensive than others of the plurality of signal classifiers. In this manner the controller reduces the computing and battery power consumption by the RF environment learning module, for example as compared to known classifier systems.

In another example, the trained ML sensing controller determines a sensing and signal processing plan based on knowledge of a current RF spectrum environment, e.g., based on historical RF spectrum information and/or based on results of a previous spectrum sensing and signal classification operation. This is advantageous in that the RF environment learning module uses multiple criteria to determine that one or more regions of spectrum are not likely to include signals of interest and then avoid spending computing and battery resources attempting to classify those regions of spectrum. In one configuration, the machine-learning sensing controller avoids sensing and attempting to classify regions of spectrum that did not include signals of interest during one or more previous sensing and classification operations. In another configuration, the machine-learning sensing controller avoids sensing and attempting to classify regions of spectrum that are predicted by the trained ML sensing controller to not include signals of interest, e.g., radar signals and signals transmitted by primary users of a region of spectrum, and regions of spectrum that are not likely to include signals of interest based on knowledge of historical spectrum usage. In a further configuration, the trained ML sensing controller performs sensing on regions of spectrum regardless of a determined likelihood that the regions include signals of interest (e.g., to attempt to determine what types of signals are present in the spectrum environment of the regions or to classify sub-noise signals that were not predicted to be present in the spectrum environment).

An example process for generating and executing signal sensing and processing plans (4000) is illustrated in FIGS. 4A and 4B. Process (4000) is carried out by a trained ML sensing controller (2410) in cooperation with other components of an RF environment learning module.

In FIG. 4A, process (4000) initiates at (A). At step (4010), the trained ML sensing controller selects, from the options described in Table 1, one or more ML classifiers and one or more feature extractors to use for processing of I/Q data to generate classification results. The trained ML sensing controller selects, from a ML classifier data store (2240) that includes a plurality of trained ML classifiers, one or more machine-learning-based classifiers to execute (e.g., classifiers (2250a-c)). The trained ML sensing controller determines one or more feature vectors that are required as inputs for the selected machine-learning-based classifiers and selects, from a feature extractor data store (2210) one or more feature extractors (e.g., feature extractors (2220a-b)) to generate the feature vectors. The trained ML sensing controller determines RF signal data that is needed to generate the required feature vectors.

At step (4020), the trained ML sensing controller generates a signal sensing and processing plan (2500) that includes system components, settings, and schedules configured to collect and process RF signal data and to generate signal classification results.

The sensing and signal processing plan includes the one or more machine-learning-based classifiers and the one or more feature extractors that the trained ML sensing controller selected at step (4010). The sensing and signal processing plan includes an execution order of the selected classifiers in accordance with reasoned information. When determining the execution order, the trained ML sensing controller weighs the selected classifiers in order to optimize at least one of: power usage, sensing time, or minimizing the average number of classifiers executed before a signal is classified, when the selected classifiers are executed for signal classification operations in the current RF spectrum environment.

The sensing and signal processing plan further includes configuration settings for the signal receiver component, e.g., center frequencies and frequency bandwidths to sense, as well as a timing schedule for sensing, e.g., when to sense a particular spectrum range and for how long.

### 1.6.1 Example Data Flows

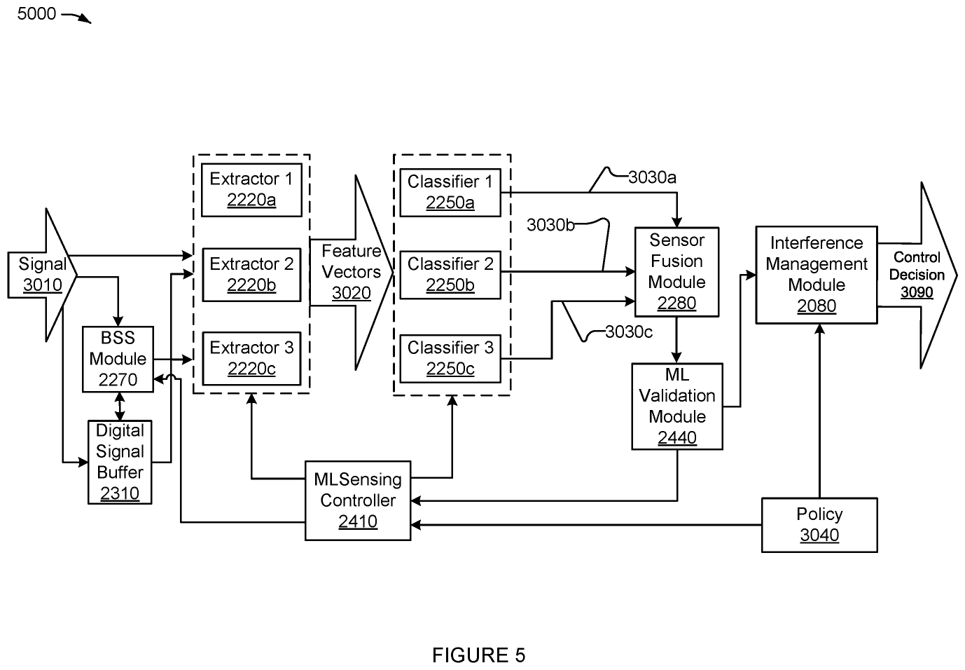

General information flow (5000) through an example embodiment of an RF environment learning module as disclosed herein is illustrated in FIG. 5. Referring to FIGS. 3, 4A, 4B, and 5, execution of a sensing and signal processing plan to perform RF spectrum sensing is initiated by the RF environment learning module, configuring and controlling the operation of one or more signal receiver components (2010) in order to perform RF spectrum sensing.

At step (4030), according to the sensing and signal processing plan, the trained ML sensing controller configures settings and sensing schedules for one or more signal inputs (2600) to obtain and process RF signal data to generate digital data, e.g., digital I/Q data.

At step (4040) the trained ML sensing controller causes the one or more signal receiver components to sample RF spectrum data according to the configured settings and sensing schedules and to perform signal processing on the sampled RF spectrum data to generate digital I/Q data. Sensing is configured to capture data samples that are useful for extracting waveform protocol layer as well as physical layer characteristics. The signal receiver component (2010) digitizes the analog radio signal data received from the signal input (2600) to generate digital RF signal data (3010) which is passed directly to one or more feature extractors (2220a-c) or stored in a digital signal buffer (2310) for further processing.

In some embodiments, the trained ML sensing controller causes the RF environment learning module to store, at step (4050), the digital I/Q data in a digital signal buffer (2310) to facilitate further processing of the digital I/Q data including, in some embodiments, blind source separation (2270) and other offline data processing operations as well as re-use of the digital I/Q data by individual feature extractors and machine-learning-based classifiers. In a particular embodiment, the RF environment learning module provides a copy of a digital I/Q sample to one or more feature extractors and stores another copy of the digital I/Q sample in the digital signal buffer.

The RF environment learning module processes the stored copy of the digital I/Q sample using one or more different techniques. In an embodiment, if processing of the digital I/Q sample using a first technique does not result in a successful signal classification result, the RF environment learning module processes the stored copy of the digital I/Q using a second technique, e.g., using one or more different feature extractors and/or machine learning classifiers.

At step (4055), the trained ML sensing controller configures one or more feature extractors (2220a-c) to process digital I/Q data to extract feature vector(s), and configures one or more machine-learning-based classifiers (2250a-c) to process the extracted feature vector(s) to generate one or more signal classification results.

At step (4060), the trained ML sensing controller causes the configured feature extractors (e.g., (2220a-c)) to extract features from the digital I/Q data. The one or more selected feature extractors generate feature vectors by processing the digital RF signal data using known feature extraction techniques and algorithms. The feature extractor(s) provide extracted feature vectors (3020) to one or more machine-learning-based classifiers. Examples of extracted features include one or more of: Power Spectral Density (PSD), I/Q sync patterns, spectrogram features (e.g. RF frequency, Pulse Repetition Interval (PRI), and Pulse Width (PW)), duty cycle, eye patterns, and cyclostationary profile. Examples of classifiers include trained Long Short-Term Memory (LSTM) and convolutional neural network (CNN) classifiers.

At step (4070), the trained ML sensing controller causes the one or more configured ML classifiers (e.g., 2250a-c) to process the extracted features to generate one or more classification results. In an embodiment, a single ML classifier (e.g. 2250a) processes one or more extracted features to generate a classification output (e.g. 3030a). Alternatively, each of multiple selected ML classifiers (e.g. 2250a-c) processes one or more extracted features to generate a classification output (e.g. 3030a-c). Signal classification outputs include identification of signal channelization and signal type, including identification of sub-noise floor signals.

At step (4080), if multiple classification outputs were generated at step (4070), the trained ML sensing controller causes the sensor fusion module (2280) to process the multiple classification outputs to generate a unitary fused classification result. The sensor fusion module uses a Kalman filter scheme or a machine learning approach to fuse multiple classifier outputs to generate the unitary classification result. In some embodiments, the unitary classification result includes a confidence statistic that is used as an input by a machine learning-based validation module (2440) to generate a classification validation or verification result.

The RF environment learning module may include a machine learning-based validation module (2440) which reasons over classification results. The validation module includes a machine learning model trained on data that includes historical classification results, sensing plan configuration, time, location, date, known emitter types, and other information regarding an RF environment. The validation module either validates or rejects a signal classification result. The validation module uses a confidence statistic generated by the sensor fusion module as an input to the classification validation result. For example, the validation module only validates classification results that include a confidence statistic with greater than a threshold value. In an embodiment, the validation module generates a confidence score or probabilistic score associated with a classification result.

At step (4090), the trained ML sensing controller causes the validation module (2440) to reason over one or more classification outputs or a fused classification result to generate a classification validation result, i.e. to determine whether a signal classification is valid, e.g., whether a signal classification is reasonable in light of considerations such as a geographical location or spectrum range corresponding to sensing performed in step (4040). The validation module provides the classification validation result to the trained ML sensing controller.

In an example of a classification validation determination by the validation module, if a sensing and signal processing plan did not include scanning of spectrum known to be used by LTE system, the validation module determines that an LTE signal classification result is unreasonable and assigns a low confidence score to the LTE classification result.

In another example of a classification validation determination by the validation module, if a sensing and signal processing plan that included scanning LTE spectrum in a location that has historically included LTE signals, the validation module validates an LTE signal determination and assigns a relatively high confidence value to the determination, for example 95% confidence. System or device components, for example interference management module (2080) and channel management module (2090), use the confidence score as an input for one or more management decision making processes. For example the interference management module determines that a cognitive radio should change to a new communication channel or reduce power if the validation module determines that a current operating channel includes a signal classified as a primary signal with greater than a threshold confidence, for example greater than 50% confidence. The interference management module (2080) and channel management module (2090) also use stored (2060) policies (3040) to make management decisions (3090).

At step (4100), the trained ML sensing controller (2410) determines whether the validation module (2440) generated a classification validation result indicating that a classification is validated and, if so, provides the signal classification result, and in some embodiments an associated confidence statistic, to the interference management module (2080). The interference management module provides signal classification results to the channel management module (2090).

If, at step (4100), the trained ML sensing controller determines that the validation has rejected a classification result, i.e., if implementation of a previous sensing and signal processing plan failed to successfully classify signals, the trained ML sensing controller adjusts the previous sensing and signal processing plan or generates a new sensing and signal processing plan. At step (4110), the trained ML sensing controller determines whether all known configurations have been tried, i.e. whether there are one or more remaining configurations of RF spectrum sensing, feature sets, and/or ML classifiers that the trained ML sensing controller employs in an attempt to classify a signal.

If the trained ML sensing controller determines that at least one more configuration has not been tried, then at step (4120) the trained sensing controller generates a new signal sensing and processing plan or alters an existing signal sensing and processing plan, including generating or altering one or more aspects of the existing signal sensing and processing plan.

A first altered aspect of a signal sensing and processing plan includes reconfigured spectrum sensing parameters, for example adjusting the center frequency, frequency range, or timing parameters of RF sampling parameters.

A second altered aspect of a signal sensing and processing plan includes scheduling one or more additional operations to resolve overlapping or interfering signals. For example, if a first signal classification operation fails to classify signals, the trained ML sensing controller examines the classification results and determines that the failure was due to overlapping signals. The trained ML sensing controller then schedules a second signal classification operation that includes a signal processing operation configured to separate overlapping signals. For example, the trained ML sensing controller schedules a blind signal separation (BSS) module (2270) to perform blind source separation on RF signal data to resolve overlapping or simultaneous signals. BSS module (2270) uses one or more methods to separate signals including, for example, one or more of Independent Component Analysis (ICA), Principal Component Analysis (PCA), and Singular Value Decomposition (SVD).

A third altered aspect of a signal sensing and processing plan includes one or more additional, or alterative, feature extractors and/or machine learning classifiers. In an implementation, the trained ML sensing controller determines that a ML classifier failed to classify a signal by processing spectrogram features extracted from an I/Q sample. In response, the trained ML sensing controller schedules a cyclostationary feature extractor to extract one or more cyclostationary feature sets from a buffered version of the I/Q sample and schedules the same and/or one or more other ML classifiers to process the cyclostationary feature set to generate a new classification result. In a further or alternative implementation, the trained ML sensing controller selects and schedules one or more additional feature extractors and ML classifiers to process new I/Q samples collected during implementation of a new or altered signal sensing and processing plan.

A fourth altered aspect of a signal sensing and processing plan includes processing of buffered I/Q data to adjust the center frequency, amplitude, and relative frequency of one or more I/Q samples prior to performing repeated or different feature extraction and ML classification on the buffered I/Q sample.

The trained ML sensing controller may begin implementation of a new or altered signal sensing and processing plan at step (4130). The trained ML sensing controller determines whether the new or altered signal sensing and processing plan includes additional sampling of RF spectrum and, if so, returns to step (4030) to configure signal receiver components for sampling and processing of RF spectrum data. If the trained ML sensing controller determines that the new or altered signal sensing and processing plan does not include collection of new spectrum data, the trained ML sensing controller returns to step (4055) to configure one or more feature extractors and/or ML classifiers to process buffered I/Q data. The trained ML sensing controller optionally schedules blind signal separation at step (4140) to resolve overlapping signals.

The RF environment learning module first implements a simple sensing and signal processing plan. If the simple signal processing plan fails to classify a signal, the RF environment learning module then implements a more complex, and more resource intensive, sensing and signal processing plan.

The generation and update, by the RF environment learning module, of one or more sensing and signal processing plans is advantageous in that machine-learning signal classifiers are dynamically selected based on a number of factors including predicted success of selected classifiers, resource consumption of selected classifiers, and previous signal classification results, to perform signal classification operations with reduced computing and battery resource use.

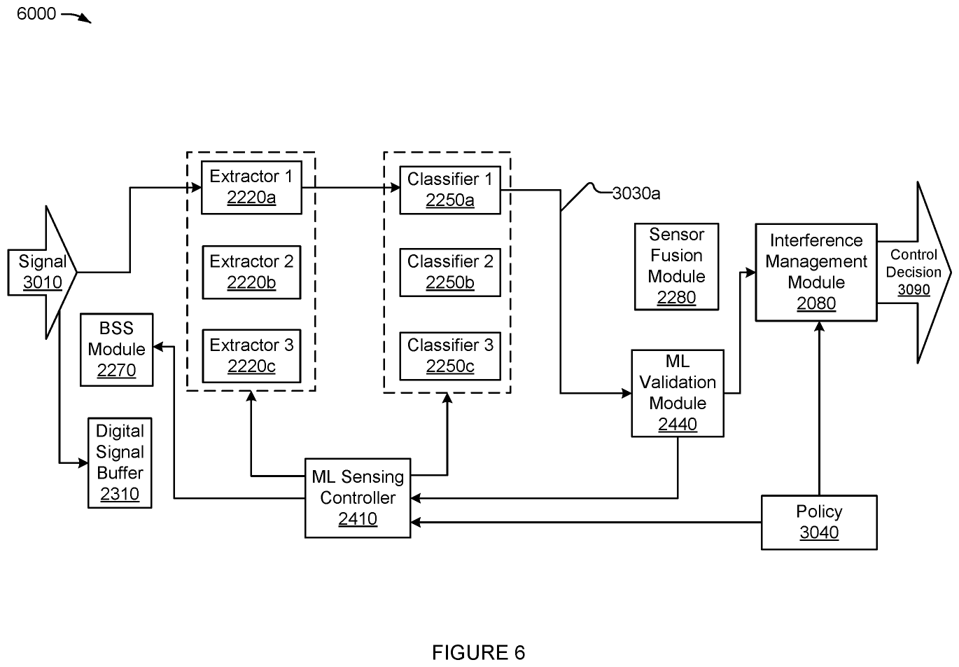

FIG. 6 illustrates an information flow (6000) of an implementation of a simple sensing and signal processing plan as disclosed herein. The sensing and signal processing plan illustrated in FIG. 6 may be implemented by an RF environment learning module as disclosed herein, such as during an initial attempt to classify a particular region of spectrum. The trained ML sensing controller (2410) configures a single feature extractor (2220a) to extract a feature set from digital RF signal (3010). The feature set is provided, by the feature extractor, to classifier (2250a) which processes the feature set to generate a classification result. Other extractors (2220b,c) and classifiers (2250b,c) are available, but not selected by the trained ML sensing controller for this initial pass. Because only one signal is input to the extractor, the BSS module (2270) is not used. Because only one signal classifier is used, the sensor fusion module (2280) is not used. The machine-learning validation module (2440) reasons over the classification result (3030a) and either validates or rejects the classification result. A copy of the signal is optionally stored in the digital signal buffer (2310) if further processing is required. A successful classification result is used by the Interference Management Module (2080) as an input for one or more decision making processes (3090), or are sent to the interference management module or the channel management module for use in managing the radio operation. In an implementation of the classification plan illustrated in FIG. 6, feature extractor (2220a) extracts spectrogram data from digital RE signal (3010) and classifier (2250a) is a spectrogram based classifier.

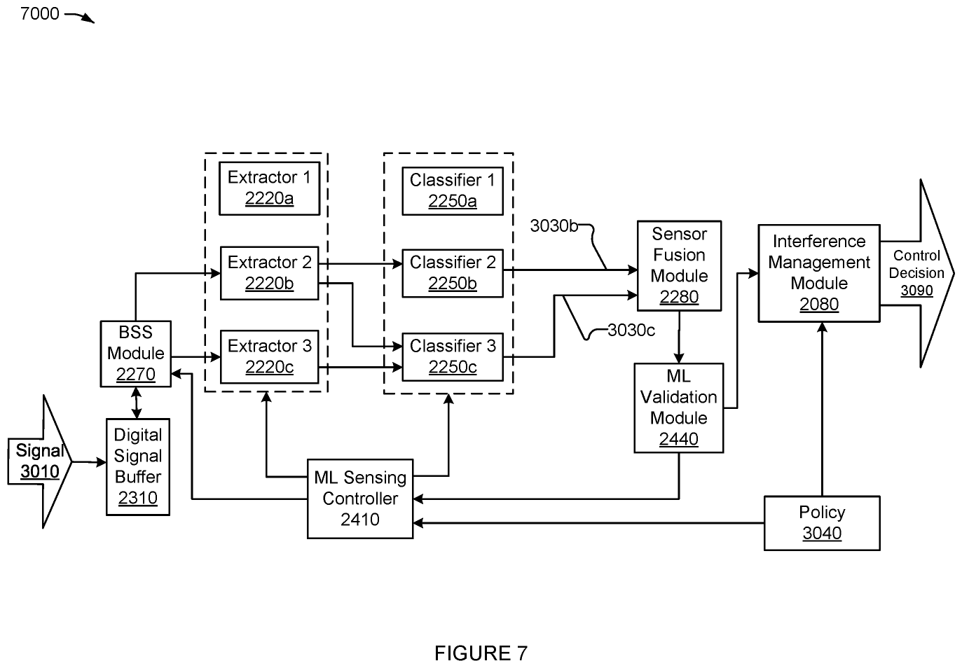

FIG. 7 illustrates an information flow (7000) as disclosed herein, which may be used as a more complex, resource intensive, sensing and signal processing plan and may be implemented, for example, if the simple sensing and signal processing plan illustrated in FIG. 6 fails to classify a signal. Digital RF signal (3010) is stored in digital signal buffer (2310) after the initial pass described in FIG. 6. The trained ML sensing controller (2410) configures the BSS module (2270) to separate overlapping signal data from the buffer for input to multiple feature extractors (2220b-c). The trained ML sensing controller configures the feature extractors to extract multiple feature sets. The feature sets are provided, by the feature extractors, to multiple classifiers (2250b-c), which process the feature sets to generate classification results (3030b-c). Depending on configuration, as determined by the ML sensing controller, a classifier receives feature sets from one or more feature extractors. Other extractors (2220a) and classifiers (2250a) are available, but not selected. Because multiple signal classifiers were used and multiple results were output, the sensor fusion module (2280) is used to generate a unitary fused classification result, using the multiple results from the classifiers as input. The machine-learning validation module (2440) then reasons over the unitary fused classification result and either validates or rejects the classification result. A successful classification result is used by the interference management module (2080) as an input for one or more management decision making processes. (3090)

The RF environment learning module iteratively implements modified sensing and signal processing plans until one or more signals in a particular spectrum region are successfully classified or a new signal type is established. The trained ML sensing controller modifies multiple aspects of the iteratively implemented sensing and signal processing plans including, for example, sensor parameters, extracted features, and machine-learning-based classifiers used. In addition, the trained ML sensing controller generates sensing and signal processing plans that concentrate resources on regions of spectrum that require more processing, e.g., regions that were found to contain signals during earlier sensing or that are predicted, by the trained ML sensing controller, to contain signals.

The RF environment learning module repeats process (4000) to continue sensing and characterizing signals and signal channelization within a region of spectrum or spectrum environment and to determine and track changes in the spectrum environment over time.

### 1.6.2 Dynamic Retraining to Generate Models of New Signal Types

Referring once again to FIGS. 4A and 4B, in some embodiments the RF environment learning module performs dynamic, real time, training of one of more ML classifiers to dynamically configure the RF environment learning module for classification of the new signal type. In these embodiments, the RF environment learning module includes a novelty detection module (2430) which is configured to determine whether a signal received by the RF environment learning module is a new signal, i.e., a signal of a type for which the RF environment learning module does not include a trained ML classifier.

The novelty detection module is configured to detect new signals using a known novelty or outlier detection technique, for example, one or more of a probabilistic, distance-based, reconstruction-based, domain-based, and information-theoretic based technique. In an embodiment, the novelty detection module includes a ML model or algorithm that is trained on one or more known signal types to recognize inlier signals in sample data, for example by defining one or more inlier boundaries within a representation of feature vectors generated by one or more feature extractors. In this embodiment, the novelty detection module classifies, as outliers, signals that the trained ML model or algorithm does not classify as inlier signals.

In an embodiment, the novelty detection module includes a single ML model that is trained on each of the signal types that the RF environment learning module is configured to classify; for example, on each of LTE, Wi-Fi, and one or more radar signal types. Alternatively, the novelty detection module includes multiple ML models, each trained on a single signal type or on a class of signal types that includes multiple individual signal types. In an embodiment, the novelty detection module includes at least one trained state vector machine (SVM) model. Alternatively or in addition, the novelty detection module includes one or more of a Minimum Covariance Determinant (MCD) classifier and k-means clustering classifier.

If, at step (4110), all known configurations of the trained ML sensing controller and ML classifiers have already been employed to classify a signal on a particular I/Q sample set without a successful classification result, the trained ML sensing controller proceeds to (B) and enters into a real-time ML training mode, which is illustrated in FIG. 4B.

The trained ML sensing controller configures the novelty detection module to perform novelty detection. At step (4200), the novelty detection module generates output that includes whether or not the novelty detection module has detected a new signal type and, if so, information related to the new signal type including the feature(s), classifier(s), and frequency index/indices used by the anomaly detector to determine the new signal. If the novelty detection module does not determine that a new signal has been encountered, the trained ML sensing controller returns to step (A) where it continues spectrum sensing including scheduling sweeping scans and signal classifications.

If, at step (4200), the novelty detection module determines that a new signal has been encountered, then, at step (4205), the trained ML sensing controller configures the RF environment learning module to perform dynamic, real-time, training of a new or existing ML model to generate a ML model that is trained to recognize the new signal type.

In an embodiment, at step (4205), the trained ML sensing controller causes the RF environment learning module to stop performing sweeping scans and signal classification over multiple regions of spectrum and to “park” in the new signal spectrum region by configuring signal receiver components to collect RF data from the selected signal spectrum region (step 4210) and to process the collected RF data to generate, and store in the digital signal buffer, digital I/Q data corresponding to the new signal spectrum region.

At step (4220) the trained ML sensing controller causes one or more feature extractors to process the digital I/Q data to generate one or more features or feature vectors corresponding to the new spectrum region. In an embodiment, the trained ML sensing controller stores a first portion of the features or feature vectors as training data and a second portion of the features or feature vectors as testing data.

In an embodiment, the RF environment learning module includes a classifier training module (2520) which is configured to perform training, e.g., unsupervised training, of one or more ML models or algorithms to generate a trained new signal ML classifier, i.e., a new or retrained ML classifier that is configured to classify signal of the new signal type. At step (4230), the classifier training module uses the extracted features or feature vector training data to train the one or more ML models or algorithms and generates at least one trained new signal ML classifier.

At step (4240) the trained ML sensing controller evaluates an ability of a trained new signal ML classifier to successfully identify a signal of the new signal type based on digital I/Q data samples. In an embodiment, the trained ML sensing controller causes the trained new signal ML classifier to process feature or feature vector testing data to generate signal classification results. The trained ML sensing controller uses one or more performance metric comparisons to evaluate the ability of the trained new signal ML classifiers to identify the new signal type. For example, the trained ML sensing controller determines whether the trained new signal ML classifier is able to successfully classify the new signal type on greater than a threshold number of classification attempts or with greater than a threshold level of confidence.

If, at step (4250), the trained ML sensing controller determines that the ML model or models that include the trained new signal ML classifier are not sufficiently trained, the trained ML sensing controller may return to step (4210) to cause the RF environment learning module to collect and process additional sensing data to generate additional training data and to cause the classifier training module to perform further training of the trained new signal ML classifier using the additional training data. The trained classifier scheduler iterates the data collection and processing, model training, and model evaluation steps (4210 through 4240) multiple times until it determines that trained new signal ML classifier has been successfully configured and trained. During successive iterations, the trained ML sensing controller configures the RF environment learning module to extract different feature sets and/or to train or retrain different ML models or algorithms until it determines a combination of feature sets and ML models and/or algorithms that are effective for classifying the new signal type.

When the trained ML sensing controller determines that a new signal ML classifier has been successfully trained to classify the new signal type, it saves the trained new signal ML classifier to feature extractor storage (2210) with a tag that includes indication of which features or feature sets are processed as inputs by the trained new signal ML classifier to generate a classification result.

In some embodiments, the RF environment learning module shares a trained new signal ML classifier with one or more other RF environment learning modules or with a central controller or server (4270), which, in turn, disseminates the trained new signal ML classifier to one or more RF environment learning modules. In this manner, when another RF environment learning module encounters the new signal type it does not need to spend resources training ML classifiers to classify the new signal type.

After saving, and optionally sharing, a trained new signal ML classifier, the MLFMLS exits real time training mode and returns to (A) of FIG. 4A to perform further signal classification sweeps.

### 1.6.3 Sub-Noise Floor Signal Detection

The RF environment learning module optionally performs sub-noise floor signal detection. The system may require a relatively large number of RF samples over a relatively long sensor snapshot window to perform sub-noise floor signal detection. For example, the RF environment learning module may collect sensor snapshots that range from 10 ms to 100 ms in duration to perform sub-noise floor signal detection. In contrast, a sensor snapshot used for other types of signal classification is typically approximately 1 ms in duration. Collecting the relatively long duration sub-noise floor snapshots may interrupt rapid scanning of a region of spectrum to classify other types of signals. Because of this interruption, in some embodiments the RF environment learning module operates in a default mode wherein sub-noise floor detection is not performed. If an operator or user determines that sub-noise floor signal detection is required or useful, for example, to determine if a known primary user is using a particular frequency range (e.g., a TV signal or military signal in a particular region of spectrum), the operator or user schedules sub-noise floor detection for the particular frequency range.

In an embodiment, when sub-noise floor detection is requested for a particular frequency range, the trained ML sensing controller configures one or more signal inputs (2600) with settings and a sensing schedule to collect RF data using sensor snapshots of a duration configured to enable capturing of sufficient amounts of data for sub-noise signal detection and to process the RF data to generate digital I/Q data. The trained ML sensing controller configures a cyclostationary feature extractor to process I/Q data to generate one or more cyclostationary profiles or feature sets. The trained ML sensing controller schedules a trained ML classifier to process the one or more cyclostationary profiles or feature sets to generate a classification result, which is reasoned over by the validation module to generate a validated or rejected classification result, as described herein.

### 1.6.4 Differentiation Between Signals of Different Types

In an embodiment, the RF environment learning module may differentiate between multiple signal types using one or more ML classifiers that are trained on feature sets that include characteristics that are specific to RF signal protocol level characteristics.

In an embodiment, the trained ML sensing controller schedules one or more spectrogram profile extractors to process digital I/Q sample data to generate one or more spectrogram feature sets. The trained ML sensing controller selects one or more trained LTE/Wi-Fi ML classifiers that have been trained using training data including LTE spectrogram feature sets and Wi-Fi spectrogram feature sets. The one or more trained LTE/Wi-Fi ML classifiers may include a trained convolutional neural network (CNN) model. The one or more trained LTE/Wi-Fi ML classifiers receive spectrogram feature sets from the one or more spectrogram profile extractors and process the one or more spectrogram feature sets to generate classification results that include a classification of LTE or Wi-Fi signals. The validation module reasons over the classification results and either validates or rejects the classification results, as described herein.

In an embodiment, the trained ML sensing controller schedules a duty cycle extractor to generate one or more duty cycle feature sets by processing digital I/Q data and schedules a trained LSTM classifier to classify multiple signal types based on protocol level features that are learned during training of the LSTM classifier.

In an embodiment, the trained ML sensing controller schedules a spectrogram feature extractor to extract spectrogram features from digital I/Q data and a duty cycle feature extractor to extract duty cycle features from digital I/Q data. The trained ML sensing controller schedules a CNN classifier to process the spectrogram features to generate first classification results and a LSTM classifier to process the duty cycle features to generate second classification results. The CNN classifier and LSTM classifier generate the first and second classification results and the sensor fusion module fuses the first and second classification results to generate a fused classification result.

### 1.7 Conclusions

It will also be recognized by those skilled in the art that, while the technology has been described above in terms of preferred embodiments, it is not limited thereto. Various features and aspects of the above described technology may be used individually or jointly. Further, although the technology has been described in the context of its implementation in a particular environment, and for particular applications (e.g. using machine learning techniques for unsupervised classification of RF signals), those skilled in the art will recognize that its usefulness is not limited thereto and that the present technology can be beneficially utilized in any number of environments and implementations where it is desirable to use feature vector extractors and classifiers to identify unknown signals of any type without requiring supervision. Accordingly, the claims set forth below should be construed in view of the full breadth and spirit of the technology as disclosed herein.

What is claimed:

1. A method of operating a DSA-enabled radio comprising a radio frequency (RF) environment learning module, the method comprising:
obtaining a signal representation of a portion of RF spectrum received by a radio receiver in a first RF environment,
performing a predefined first signal sensing and processing plan to obtain an initial feature extraction and/or classification of the signal representation based upon a predefined first signal sensing and processing plan,
where the signal is not classified by the predefined first signal sensing and processing plan, determining an additional feature extraction and/or signal classification to be performed based upon an output of an RF environment learning module,
performing the additional feature extraction and/or signal classification,
classifying the signal based upon a result of the additional feature extraction and/or signal classification, and
generating a second predefined signal sensing and processing plan associated with the first RF environment based upon the additional feature extraction and/or signal classification.

2. The method of claim 1, wherein the predefined first signal sensing and processing plan includes one or more machine-learning-based classifiers and one or more feature extractors.

3. The method of claim 2, wherein the one or more machine-learning-based classifiers and the one or more feature extractors are selected by a trained ML sensing controller based on the signal representation.

4. The method of claim 1, wherein the additional feature extraction and/or signal classification comprises a modification of a feature extraction and/or signal classification in the predefined first signal sensing and processing plan.

5. The method of claim 1, wherein the second signal sensing and processing plan comprises a new or retrained machine-learning-based classifier that is trained to recognize the classified signal.

6. The method of claim 5, wherein the classified signal comprises a previously-known signal type occurring in a spectrum band different from an original spectrum band associated with the previously-known signal type.

7. The method of claim 6, wherein the previously-known signal type comprises a WiFi signal identified in a spectrum band not authorized for WiFi use.

8. The method of claim 1, wherein the RF environment learning module causes the first signal sensing and processing plan to be generated based on historical RF data.

9. The method of claim 1, wherein the first signal sensing and processing plan comprises a first signal classification operation and a second signal classification operation performed after the first signal classification operation when the first signal classification operation fails to classify the signal, and wherein the second signal classification operation is more resource-intensive to execute by the DSA-enabled radio than the first.

10. The method of claim 1, wherein performing the first signal sensing and processing plan comprises reconfiguring one or more spectrum sensing parameters.

11. The method of claim 1, wherein performing the first signal sensing and processing plan comprises scheduling one or more additional operations to resolve overlapping or interfering signals.

12. The method of claim 1, wherein performing the first signal sensing and processing plan comprises processing buffered I/Q data to adjust the center frequency, amplitude, and/or relative frequency of one or more I/Q samples.

13. The method of claim 1, wherein the step of determining an additional feature extraction and/or signal classification to be performed based upon an output of an RF environment learning module is performed based upon detection of a new signal by a novelty detection module.

14. The method of claim 13, wherein the novelty detection module comprises a machine learning model trained on one or more signal types to identify inlier signals in the signal representation.

15. The method of claim 13, wherein the novelty detection module comprises a machine learning model trained on a plurality of signal types that the RF environment learning module is configured to classify.

16. The method of claim 15, wherein the signal types comprise LTE signals, WiFi, signals, and radar.

17. A DSA-enabled radio, comprising:
a RF environment learning module;
a radio transceiver;
a computer-readable memory storing historical radio spectrum data;
a computer processor; and
a plurality of instructions which, when executed by the processor, cause the processor to perform one or more unsupervised machine learning classifications of RF input signals received by the radio transceiver that cannot be classified using the historical radio spectrum data.

18. The DSA-enabled radio of claim 17, wherein the plurality of instructions cause the processor to execute one or more modules selected from the group consisting of:
a sensing controller that creates a signal sensing and processing plan;
a classifier trainer that trains the DSA radio system to recognize a new signal type; a novelty detector to collect additional RF signal data and identify a feature extractor to extract signal attributes from the additional RF signal data; and
an ML validator to verify signal classification results using ML statistical methods.
